(19) United States
(12) Patent Application Publication
(10) Pub. No.: US 2003/0077491 A1
(43) Pub. Date: Apr. 24, 2003

(54) Weight sensing system, method for use thereof, and electrochemical system for use therewith

(76) Inventor: Mark A. Lillis, Windsor, CT (US)

Correspondence Address: CANTOR COLBURN, LLP, 55 GRIFFIN ROAD SOUTH, BLOOMFIELD, CT, 06002

(21) Appl. No.: 10/065,464

(22) Filed: Oct. 22, 2002

Related U.S. Application Data
(60) Provisional application No. 60/335,083, filed on Oct. 24, 2001.

(51) Int. Cl. H01M 8/04; C25B 9/08

(52) U.S. Cl. 429/22; 429/34; 429/13; 429/23; 204/252

(57) ABSTRACT

Disclosed herein are weight sensing systems, electrochemical cell systems, methods for operating an electrochemical system, and processes for controlling a liquid level in a fluid vessel. In one embodiment, the electrochemical cell system comprises: an electrochemical cell stack, a fluid containment vessel comprising a vessel inlet in fluid communication with a stack outlet and a vessel outlet in fluid communication with a stack inlet, wherein the vessel inlet comprises an inlet control device, and wherein the outlet comprises an outlet control device; and a load cell disposed in operable communication with the fluid containment vessel.

### CROSS REFERENCE RO RELATED APPLICATIONS

The present application claims priority to Provisional Patent Application Ser. No. 60/335,083 filed Oct. 24, 2001, which is incorporated herein by reference, in its entirety.

### BACKGROUND

Electrochemical cells are energy conversion devices that are usually classified as either electrolysis cells or fuel cells. Proton exchange membrane electrolysis cells function as hydrogen generators by electrolytically decomposing water to produce hydrogen and oxygen gases. Referring to FIG. 1, a section of a typical anode feed electrolysis cell is shown generally at 10 and is hereinafter referred to as “cell 10.” In this example, process water 12 is fed into cell 10 at an oxygen electrode (anode) 14 to form oxygen gas 16, electrons, and hydrogen ions (protons). The chemical reaction is facilitated by the positive terminal of a power source 18 being connected to the anode 14 and a hydrogen electrode (cathode) 20. Oxygen gas 16 and a first portion 22 of process water are discharged from cell 10, while the protons and a second portion 24 of water migrate across a proton exchange membrane 26 to cathode 20. At cathode 20, second portion 24 of water, which is entrained with hydrogen gas, is removed. Hydrogen gas 28 may also be formed at cathode 20.

The second portion 24 of water, which is rich in hydrogen, is recovered by a hydrogen/water separation apparatus. The hydrogen/water separation apparatus allows the hydrogen entrained in second portion 24 of water to diffuse from the water and into the vapor phase above second portion 24 of water. The hydrogen gas is then recovered. Water is returned to the system to supplement process water 12. The hydrogen/water separation apparatus is of a limited volumetric capacity; therefore, second portion 24 of water accommodated therein oftentimes must be returned to the system before all of the entrained hydrogen gas can diffuse out of second portion 24 of water. Preferably, the separation apparatus is partially filled with water such that a desired airspace is maintained for expansion and containment of gases. A completely empty or full separator apparatus is not desired. In such a system, the level of water in the hydrogen/water separation apparatus has heretofore been sensed and controlled using level sensing and controlling techniques.

Typically, the detection and control of the water level in the hydrogen/water separation apparatus involves the disposition of sensing equipment directly into either or both the liquid and the vapor phase above the liquid. One of the most common methods of detecting and controlling the liquid level in the hydrogen/water separation apparatus (or any other type of containment vessel) involves the use of floats and/or float valves: The buoyancy of the float is used to control the amount of liquid in the vessel. Other methods include measuring the difference in static pressure between two fixed elevations, one of the fixed elevations being in the vapor phase above the liquid and the other fixed elevation being below the liquid surface. The differential pressure between the two fixed elevations is directly related to the liquid level in the hydrogen/water separation apparatus. One of the problems associated with such a method derives from the buildup of condensation in the line from which the static pressure in the vapor phase is measured. If the line fills up with condensate, the differential pressure will be zero even if the liquid level is near the fixed elevation in the vapor phase. Such a false reading will be interpreted by an operator as indicative of the vessel being empty.

Other problems that may be associated with level sensing and control techniques (particularly when liquids other than water are involved) stem from the corrosive nature of the liquid or its tendency to foul or plug equipment. In such cases, it may be necessary to prevent process liquids or gases from fluidly engaging pressure differential equipment. However, it should be noted that corrosion is not an issue with the use of deionized water. Prevention of contact between the fluids and the equipment is most often effectuated by the incorporation of diaphragm seals into the areas where the fluids and the equipment interface. The use of diaphragm seals typically requires a schedule of periodic maintenance in order to ensure that the seals are continually providing the desired level of protection to the equipment. Other ways of preventing the contact may be through the use of continuous gas purges, which require even more frequent (and possibly constant) maintenance, typically in the form of continuous monitoring. Continuous purges are difficult to control and can cause excessive hydrogen gas build-up in the separation apparatus.

Regardless of the application, when equipment required for the sensing and control of liquid levels is installed such that process fluids are in direct contact therewith, cautionary measures must generally be incorporated into the process to ensure that all of the equipment remains fully functional. Such cautionary measures typically require some amount of preventive maintenance in order to allow for the maximum operability of the equipment with as little downtime as possible. Any amount of preventive maintenance, however, typically adversely affects the overall cost of the process and should therefore be minimized.

There accordingly remains a need in the art for a cost effective and robust sensing system that can maintain a range of water in the separation apparatus and overcome the above noted problems.

### TECHNICAL FIELD

The present disclosure relates to sensing systems, and, more particularly, relates to weight sensing systems in a fluid separator vessel for maintaining a volume of liquid in the vessel within selective limits.

### SUMMARY

Disclosed herein are weight sensing systems, electrochemical cell systems, methods for operating an electrochemical system, processes for calibrating a liquid volume control system, and processes for controlling a liquid level in a fluid vessel. In one embodiment, the electrochemical cell system comprises: an electrochemical cell stack, a fluid containment vessel comprising a vessel inlet in fluid communication with a stack outlet and a vessel outlet in fluid communication with a stack inlet, wherein the vessel inlet comprises an inlet control device, and wherein the outlet comprises an outlet control device; and a load cell disposed in operable communication with the fluid containment vessel.

In one embodiment, the process for calibrating a liquid volume control system, comprises: draining liquid from a fluid containment vessel such that the vessel is substantially empty and generating a first signal, wherein the first signal is a measurement of the weight of the vessel, filling the vessel with liquid such that the vessel is substantially full of liquid and generating a second electrical signal, wherein the second electrical signal is a measurement of the vessel and the liquid contained therein, and calculating a lower weight limit and an upper weight limit based on the first electrical signal and second electrical signal.

In one embodiment, the method for operating an electrochemical system, comprises: producing a stream comprising water and a gas in an electrochemical cell stack, introducing the stream to a fluid vessel, monitoring a measured weight of the vessel, and maintaining the measured weight of the vessel between an upper weight limit and a lower weight limit by at least one of ceasing the introduction of the stream to the fluid vessel, introducing the stream to the fluid vessel, and removing liquid from the fluid vessel.

In one embodiment, the weight sensing system comprises: a containment vessel, a first conduit in fluid communication with the containment vessel, wherein the first conduit comprises a first flow control device, a second conduit in fluid communication with the containment vessel, wherein the second conduit comprises a second flow control device, and a load cell in operable communication with the containment vessel, first flow control device, and second flow control device.

In one embodiment, the process for controlling a liquid level in a fluid vessel comprises: introducing a liquid to the vessel, monitoring a measured weight of the vessel, and maintaining the measured weight of the vessel between an upper weight limit and a lower weight limit.

The above and other features will be further described in relation to the following drawings and detailed description.

### BRIEF DESCRIPTION OF THE FIGURES

FIG. 1 is a schematic diagram of a cell in an anode feed electrolysis cell.

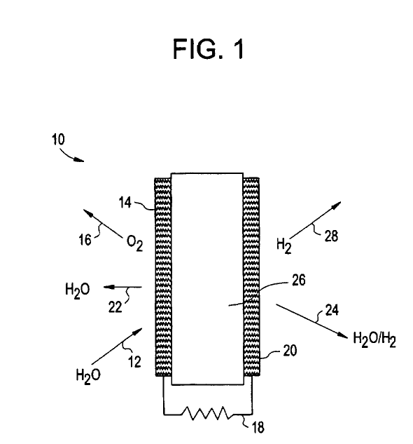

FIG. 2 is a schematic diagram of one embodiment of a weight sensing system utilizing a load cell.

FIG. 3 is a schematic diagram of another embodiment of a weight sensing system utilizing a load cell.

### DETAILED DESCRIPTION OF THE PREFERRED EMBODIMENTS

A weight sensing system for measuring a relative weight of a hydrogen/liquid separation apparatus during operation of the electrochemical cell system is described. More specifically, the weight sensing system includes the use of one or more load cells to determine the relative weight of a containment vessel of the hydrogen/water separation apparatus.

In one embodiment, the load cell is mechanically connected to a rigid wall within the electrochemical cell system. The rigid wall may be a floor, ceiling or other structural member in or about the electrochemical cell system. The load cell is adapted to measure a compressive force exerted by the relative weight of the containment vessel. Alternatively, the load cell is adapted to measure a tensile force exerted by the relative weight of the containment vessel. One or more load cells can be used for weight sensing the separation apparatus. Preferably, at least two load cells are used for system redundancy and for cross-checking to ensure operation accuracy and reliability.

Each load cell is configured to generate an electric signal responsive to the tensile and/or compressive forces generated by the weight of the vessel. Preferably, a controller and a microprocessor are in communication with the load cell and are programmed with an appropriate algorithm to automatically replenish or drain the vessel as needed.

The weight sensing system is used to set an upper relative weight limit and a lower relative weight limit for the containment vessel. The algorithm is used to program and set the desired upper and lower weight limits during use. The programmed upper and lower weight limits define the desired maximum and minimum liquid levels contained in the containment vessel during operation of the electrochemical cell system. The relative weight of the containment vessel is static. In the event the upper and lower weight limits are exceeded, the system delivers a signal to a control valve to drain or fill the containment vessel. Alternatively, the algorithm can be programmed such that the drain and fill points occur prior to the electrical signal exceeding the upper or lower weight limits such as by programming an offset value based on the upper and lower weight limits. In this manner, the weight of the containment vessel is maintained within the upper and lower weight limits, wherein the system drains or fills the vessel when the offset values are exceeded. In addition, since the approximate maximum volume of liquid can be readily determined from the dimensions of the vessel, the algorithm may include this information and use it for validating the empty and full vessel weight limits. Advantageously, a determination of the actual weight of the vessel or the actual level of water in the vessel is not required. Rather, it is the relative weight changes that are measured. The weight sensing system can be used as the primary liquid level detection system in the vessel or as a backup in conjunction with the use of float level sensors or the like.

The algorithm is programmed by measuring a desired minimum and a maximum weight value for the containment vessel during operation. For example, the minimum weight value may be a relative weight measurement of the vessel without any liquid present whereas completely filling the vessel with liquid may be used to determine the maximum level. The electrical signals generated by the load cells in response to the exerted loads on the load cell are recorded for the respective minimum and maximum values. The electrical signals can be then used to determine, with the appropriate algorithm, the signal settings defining the upper and lower limits. In practice, it is preferred to provide an offset to the upper and lower limits (determined by the algorithm) to define a band or narrow range for each respective limit. In this manner, the fill and drain points can be set at the offset limits that are well within the maximum and minimum values defined by the upper and lower weight limits. As a result, exceeding the offset values of the upper or lower limits will cause the system to automatically replenish or drain the vessel prior to the electrical signal falling outside the maximum and minimum values defined by the upper and lower limits. The drain and fill points are referred to as the upper and lower offset settings. Although reference is made to drain and fill points, the drain and fill cycles can be programmed to occur within a range set by the upper and lower offset limits; for example, in the range defined by the difference between the offset upper limit and the upper limit.

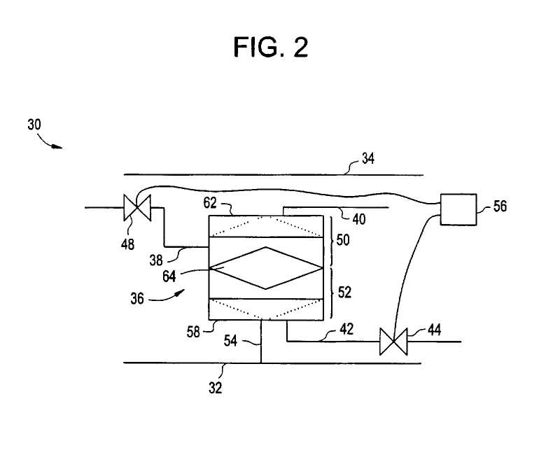

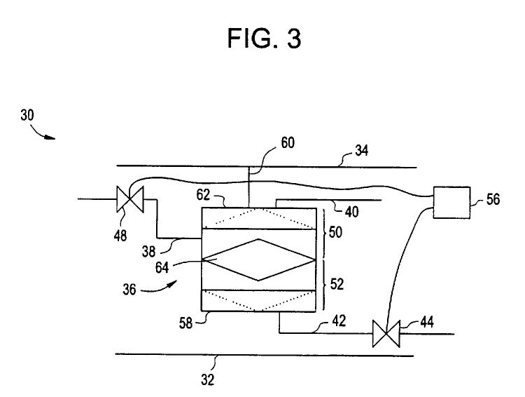

Turning now to FIGS. 2 and 3, there is shown a hydrogen/liquid separation apparatus generally designated 30 and 31, respectively. The hydrogen/ liquid separation apparatus 30, 31 is preferably disposed within an electrochemical cell system (not shown) that includes rigid and stationary support surfaces 32, 34. Optionally, the electrochemical cell system may be in an enclosure such that the rigid and stationary support surfaces are part of the enclosure or separate from the enclosure. The separation apparatus 30, 31 includes a containment vessel 36 that includes a liquid inlet conduit 38, a gas/vapor outlet conduit 40, and a liquid outlet conduit 42.

Liquid is received into the containment vessel 36 through inlet conduit 38. A fluid control device 48 is in fluid communication with the inlet conduit 38. Preferably, the liquid inlet conduit 38 fluidly communicates with an upper portion 50 of the containment vessel 36 such that, as the liquid is received into the containment vessel 36, the liquid water entrained with hydrogen gas flows under gravitational force to a lower portion 52 of vessel 36. Liquid inlet conduit 38 is also configured and preferably positioned such that liquid flows into containment vessel 36 along an inner wall to minimize splashing of the water and thereby minimizing further entrainment of the hydrogen in the water.

Liquid outlet conduit 42 is shown in fluid communication with a fluid control device 44 and in fluid communication with a lower portion 52 of the containment vessel 36 to allow for the removal of liquid by gravity, as needed. In addition, the liquid outlet conduit 42 is preferably in fluid communication with the cell stack (not shown) of the electrochemical cell system.

In one embodiment, a load cell 54 is mechanically attached to rigid surface 32 and is adapted to measure the compressive forces exerted by the containment vessel 36 on the load cell 54. For example, FIG. 2 shows the load cell 54 in operable communication with a bottom surface 58 of the containment vessel 36 for measuring the compressive force. Other configurations for measuring the compressive forces are contemplated herein. A microprocessing unit 56 is in operable communication with load cell 54 and control devices 44 and 48. In this particular embodiment, the load cell 54 generates an electrical signal in response to the compressive forces generated by the relative weight of the containment vessel 36 and its contents. Although the load cell 54 is shown connected to support surface 32, it is understood that the load cell can be connected to any rigid and stationary surface suitable for supporting the weight of the vessel and its contents.

Alternatively, as shown in FIG. 3, a load cell 60 is mechanically connected to support surface 34 and is adapted to measure the tensile forces exerted by the containment vessel 36 on the load cell 60. For example, FIG. 3 shows the load cell 60 attached to an upper surface 62 of the vessel. It is understood that other configurations for adapting the load cell 60 for measuring the tensile forces exerted by the containment vessel on the load cell are possible. The load cell 60 supports the containment vessel 36 and its contents such that the load cell 60 generates a signal (e.g., an electrical signal, optical signal, hydraulic signal, or the like) in response to the tensile forces exerted by the weight of the containment vessel 36 and its contents.

Although the load cells, 54, 60, are shown with a normal orientation with its respective surfaces 32, 34, respectively, it should be understood that non-normal orientation of the load cells is contemplated since it is the relative weights that are measured by the load cells 54, 60.

Examples of suitable load cells 54, 60, include strain gages, e.g., those commercially available from Interface, Inc., Scottsdale, Ariz., under the model number SML-50. Although a highly sensitive load cell will provide greater control, the load cell needs only to be sensitive enough to detect gross weight changes of the containment vessel 36 and its contents. Preferably, the load cell has an accuracy of about 5 percent. Inaccuracies and non-repeatability errors, for example, age and temperature changes can be accounted for in the algorithm used to define the operating parameters.

The gas/vapor outlet conduit 40 is shown in fluid communication with the upper portion 50 of the containment vessel 36 to allow for the takeoff of gas (e.g., hydrogen) from the containment vessel 36. The upper portion 50 of the containment vessel 36 is optionally configured and dimensioned to receive a float 64 to effectively prevent liquid from entering the gas/vapor outlet conduit 40 if the containment vessel 36 becomes flooded with liquid. The lower portion 52 of the containment vessel 36 is configured and dimensioned to receive float 64 and to effectively prevent gas from being forced into the liquid outlet conduit 42 in the event that gas/vapor outlet conduit 40 is closed and the containment vessel 36 contains no liquid.

The containment vessel 36 receives the liquid through liquid inlet conduit 38. The liquid preferably comprises water entrained with hydrogen gas from a cathode (not shown) of the electrolysis cell, water from a fuel cell, water from an electrolyzer, water from condensates, or the like. In the case where the liquid comprises water entrained with hydrogen gas, the hydrogen gas diffuses through the water and collects in an airspace of the containment vessel 36 where it may be removed through gas/vapor outlet conduit 40.

Optional float 64 is loosely positioned within the body portion of containment vessel 36. The buoyancy of float 64 enables float 64 to translate between the upper portion 50 and the lower portion 52 of the containment vessel 36 as the level of liquid within the vessel varies. Float 64 is preferably fabricated of polypropylene and is molded into a shape having outer dimensions that are conducive to the uninhibited translation between the upper portion 50 and lower portion 52. The shape and outer dimensions of float 64 may be complementary to the shape and inner dimensions of the body portion of containment vessel 36. The float(s) can be employed in conjunction with the load cell 54, 60 (as a primary or back-up system) or the load cell (s) can eliminate the float(s).

The load cells 54, 60, are shown in operable communication (e.g., electrical, and the like) with the microprocessing unit 56. For example, microprocessing unit 56 receives an output electrical signal generated by a load exerted on the load cell 54, 60, and may be used to provide a control signal usable by control devices 44, 48. In particular, the output electrical signal generated by the load cell 54, 60, assumes a characteristic voltage that is indicative of the relative weight of the vessel and its contents. Electrical communication is maintained between the microprocessing unit 56 and control devices 44, 48, which are typically valves (e.g., a high-pressure solenoid valve, a proportioning valve, or the like.

The separation apparatus 30 advantageously can be used to auto-calibrate at an electrochemical system startup. The auto-calibration process determines, by algorithm, the upper and lower weight limit for the containment vessel 36. For example, at system startup, the control device 44 may be programmed to open and drain the containment vessel 36 to a desired minimal weight level. Once the desired minimum level in the containment vessel 36 is reached, control device 44 is closed. A signal corresponding to the minimum level is generated by the load cell 54, 60, and is stored in the microprocessor 56. Preferably, the containment vessel 36 is completely emptied during the initial steps of the auto-calibration process. An empty state for the containment vessel may be determined by a time-based limit on the drain, be based on an estimate of the empty weight of the vessel, or be determined after a steady state of the weight measurement has been reached, or the like. The control device 48 is then opened for a predetermined time to allow liquid to enter the containment vessel 36 through inlet conduit 38 and fill the containment vessel 36 to a desired maximum volume or weight level. Once the containment vessel 36 fills to the desired level, the microprocessor 56 records the signal generated by the load cell 54, 60. The algorithm can then use the signals determined during the auto-calibration process to define the upper and lower weight limits as well as the upper and lower control limits (based on a selected offset value of the upper and lower weight limits).

The algorithm may further include data for the approximate weight or volume of the vessel (based on dimensions, or the like) to validate the algorithm developed for defining the lower weight limit. Likewise, the algorithm may be used to validate the upper weight limit based on data for the approximate weight of the vessel and its contents, e.g., based on vessel dimensions and approximations for the density of the liquid.

During operation of the electrochemical cell system, upon evaluation of an output signal from the load cell 54, 60, that exceeds the limits or control ranges, a signal, e.g., a pneumatic signal, hydraulic signal, an analog signal (such as a pulse width modulated (PWM) electrical signal, current signal, voltage signal, frequency signal, or the like), or the like, is transmitted to either control device 44 or 48, depending on whether the upper or lower limit is exceeded (or if programmed, whether the upper or lower control limit is exceeded). This signal produces a response that actuates the appropriate control device 44, 48 to adjust the weight of the containment vessel 36, i.e., replenishes or drains liquid from the containment vessel 36, accordingly. The signals used to define the relative upper and lower weight limits may be stored in a volatile and/or nonvolatile memory device of the microprocessor 56, or preferably, can be recalculated at each start-up.

Optionally, any data stored in the non-volatile memory may be used for integrity testing of the system. Since the apparatus 30 measures the relative weight of the containment vessel 36, it has been found that the apparatus is tolerant to the stiffness of the conduits (e.g., 38, 42, 40) connected to the containment vessel 36 and any other attachments not shown. Test and measurement tolerances can be considered in defining the upper and lower weight limits to assure that process inaccuracies do not affect operation, i.e., too full and/or near empty. Alternatively, an actual weight calculated by a manual test may also be used as part of the algorithm and stored by the microprocessor 56.

The separation apparatus 30 may further include redundant load cells and algorithms to select the correct value. For example, individual signals generated from two load cells may be averaged if both signals are valid or a combination of the lowest and highest weight readings may be used when more than one reading may be more conservative than the other. Also, the separation apparatus may include a shipping pin (not shown) for locking the load cell 54, 60, in a fixed position during shipment. The presence of the shipping pin minimizes damage to the load cell 54, 60, during shipment. The algorithm may also be programmed to detect the presence of the shipping pin and provide a signal to an operator to remove the pin during operation.

The following examples fall within the scope of, and serve to exemplify, the more generally described methods set forth above. The examples are presented for illustrative purposes only.

### EXAMPLE

In this example, a hydrogen/water separator apparatus was constructed as shown in FIG. 2. A load cell was positioned beneath the vessel and supported the weight of the vessel and its contents. When the vessel was drained to a minimal volume or empty volume, an electrical signal of 4.7 mV (millivolts; corresponding to about 8 pounds) was generated by the load cell and was used to define the lower weight limit.

The electrical signal corresponding to the lower weight limit was then stored in a microprocessor. The vessel was then filled to a desired level to establish the upper weight limit. The upper weight limit was set at approximately 11 pounds, which corresponds to an electrical signal of 5.6 mV. The electrical signal corresponding to the upper weight limit was then stored in the microprocessor. The wide variation in the electrical signals generated by the load cell for the upper and lower weight limits indicates the robustness of the device. Repeated empty/fill cycles were implemented and found to generally be within the defined upper and lower weight limits.

An offset value was then used to define upper and lower control limits based on the electrical signals defined for the upper and lower weight limits. For example, a 0.2 mV offset value from the measured upper and lower weight limits resulted in lower and upper control limits of 4.9 and 5.4 mV, respectively. In the event that the upper and lower control limits were exceeded, the command to fill or drain the vessel was implemented such that the weight of the vessel stayed within the measured upper and lower weight limits.

The separation apparatus 30 overcomes the disadvantages of float and static pressure systems discussed above. The weight sensing system can be used to manually or automatically replenish or drain a vessel in the apparatus during conditions that warrant such action, thereby preventing the vessel from completely filling or emptying during operation of the electrochemical cell system. The manual or automatic replenishing or draining is based upon a signal supplied by a load cell (e.g., a strain gage, or the like). Advantageously, the use of the auto-calibration process eliminates problems caused by floats binding, condensate false readings, the use of semi-rigid tubing and the use of wire connections.

While preferred embodiments have been shown and described, various modifications and substitutions may be made thereto without departing from the spirit and scope of the invention. Accordingly, it is to be understood that the present invention has been described by way of illustration and not limitation.

1. An electrochemical cell system, comprising:
an electrochemical cell stack;
a fluid containment vessel comprising a vessel inlet in fluid communication with
a stack outlet and a vessel outlet in fluid communication with a stack inlet, wherein the vessel inlet comprises an inlet control device, and wherein the outlet comprises an outlet control device; and
a load cell disposed in operable communication with the fluid containment vessel.

2. The system according to claim 1, further comprising a second load cell disposed in operable communication with the fluid containment vessel.

3. The system according to claim 1, wherein the load cell comprises a compressive force measurement device for measuring a weight of the fluid containment vessel.

4. The system according to claim 1, wherein the load cell comprises a tensile force measurement device for measuring a weight of the fluid containment vessel.

5. The system according to claim 1, further comprising a float translatably disposed in the fluid containment vessel.

6. A process for calibrating a liquid volume control system, comprising:
draining liquid from a fluid containment vessel such that the vessel is substantially empty and generating a first signal, wherein the first signal is a measurement of the weight of the vessel;
filling the vessel with liquid such that the vessel is substantially full of liquid and generating a second electrical signal, wherein the second electrical signal is a measurement of the vessel and the liquid contained therein; and
calculating a lower weight limit and an upper weight limit based on the first electrical signal and second electrical signal.

7. The process according to claim 6, further comprising recording the first signal and the second signal in a memory device of a microprocessor, wherein the microprocessor calculates the lower weight limit and the upper weight limit.

8. The process according to claim 6, wherein generating a first signal further comprises generating an electrical signal with a load cell in operable communication with the vessel.

9. The process according to claim 6, wherein the first signal and the second signal selected from the group consisting of hydraulic signals, electrical signals, pneumatic signals, and optical signals.

10. The process according to claim 6, wherein filling the vessel with liquid comprises introducing a stream from an electrochemical cell into the vessel.

11. A method for operating an electrochemical system, comprising:
producing a stream comprising water and a gas in an electrochemical cell stack;
introducing the stream to a fluid vessel;
monitoring a measured weight of the vessel; and
maintaining the measured weight of the vessel between an upper weight limit and a lower weight limit by at least one of ceasing the introduction of the stream to the fluid vessel, introducing the stream to the fluid vessel, and removing liquid from the fluid vessel.

12. A method according to Claim 1, further comprising introducing feed water to an electrolysis cell stack; producing hydrogen and oxygen; and removing the stream from a hydrogen side of the electrolysis cell stack.

13. A method according to claim 11, further comprising introducing oxidant and hydrogen to a fuel cell; producing water and electricity; and directing the stream from an oxidant side of the fuel stack.

14. A weight sensing system, comprising:
a containment vessel;
a first conduit in fluid communication with the containment vessel, wherein the first conduit comprises a first flow control device;
a second conduit in fluid communication with the containment vessel, wherein the second conduit comprises a second flow control device; and
a load cell in operable communication with the containment vessel, first flow control device, and second flow control device.

15. The system according to claim 14, wherein a plurality of load cells are in operable communication with the containment vessel.

16. The system according to claim 15, wherein the load cell comprises a compressive force measurement device for measuring a weight of the fluid containment vessel.

17. The system according to claim 15, wherein the load cell comprises a tensile force measurement device for measuring a weight of the fluid containment vessel.

18. The system according to claim 14, wherein the load cell is disposed generally normal to the containment vessel.

19. The system according to claim 14, further comprising a controller disposed in operable communication with the load cell, the first control device, and the second control device.

20. The system according to claim 14, further comprising a float translatably disposed in the containment vessel responsive to a level of a liquid contained in the containment vessel.

21. A process for controlling a liquid level in a fluid vessel, comprising: introducing a liquid to the vessel;
monitoring a measured weight of the vessel; and
maintaining the measured weight of the vessel between an upper weight limit and a lower weight limit.

22. The process according to claim 21, further comprising determining the upper weight limit by filling the vessel with the liquid and obtaining a filled vessel signal from a load cell, and determining the lower weight limit by draining the liquid from the vessel and obtaining an empty vessel signal from the load cell.

23. The process according to claim 22, wherein the filled vessel signal and the empty vessel signal are selected from the group consisting of hydraulic signals, electric signals, pneumatic signals, and optical signals.

24. The process according to claim 22, further comprising storing the filled vessel signal and the empty vessel signal in a controller.

25. The process according to claim 24, wherein the controller contains a nonvolatile memory device.
